(19) United States
(12) Patent Application Publication
(10) Pub. No.: US 2011/0066501 A1
(43) Pub. Date: Mar. 17, 2011

(54) APPARATUS AND METHOD FOR RENDERING ADVERTISING CONTENTS ON A MOBILE COMMUNICATION DEVICE

(76) Inventor: Sankalp Saxena, Bangalore (IN)

(21) Appl. No.: 12/561,270

(22) Filed: Sep. 17, 2009

(51) Int. Cl. G06Q 30/00; H04W 64/00

(52) U.S. Cl. 705/14.64; 455/456.3

(57) ABSTRACT

An apparatus and method for rendering advertising contents on a mobile communication device is disclosed. The method includes embedding a set of advertising contents provided by one or more advertisers in a memory at the time of manufacture of the mobile communication device. The method then detects one or more user activities with the mobile communication device, a user location and one or more alerts associated with the mobile communication device. Thereafter, the method identifies one or more advertising contents from the set of advertising contents in response to detecting the user activity on the mobile communication device, the user location and the at least one alert associated with the mobile communication device. Subsequently, the method renders the one or more advertising contents on the mobile communication device.

### RELATED APPLICATIONS

Benefit is claimed under 35 U.S.C. 119(a)-(d) to Foreign application Serial No. 2284/CHE/2008 entitled “Method and System for Advertising Content on a Mobile Communication Device” by Moveo Systems Private Limited., filed on 18 Sep., 2008, which is herein incorporated in its entirety by reference for all purposes.

### FIELD OF THE INVENTION

The invention generally relates to an apparatus and method for rendering advertising contents, and more specifically, to an apparatus and method for rendering advertising contents on a mobile communication device based on one or more of a user activity on the mobile communication device, a user location and one or more alerts associated with the mobile communication device.

### BACKGROUND OF THE INVENTION

Mobile communication devices have become a popular mode of communication in our daily life. Therefore, advertisers find mobile communication devices as a useful medium for advertising content, which is targeted to users of the mobile communication devices. Advertising of the content is beneficial for the advertisers for promoting their company, marketing of products and/or services, and offering various promotional sales. People in rural areas, especially in developing countries, may not be exposed to such advertising contents associated with the products and services. Hence, these people may not be aware of the products and services available in the market. This lack of reach to the advertising contents may be due to non-availability of targeted communication methods or high cost associated with mobile communication devices including the advertising contents.

The content is advertised on a mobile communication device by means of a short message service (SMS), a multimedia message service (MMS), a Voice Message, an email, a game, a video, a screen saver, web pages loaded on the mobile communication device, an audio advert and a splash screen. The content provided by the advertisers is communicated to the mobile communication device through a service provider in a communication network. In order to communicate the content to the mobile communication device, data connectivity between the mobile communication device and the service provider is required. The provisioning of data services to mobile communication devices may further add a cost load to the end user.

In absence of data connectivity between the mobile communication device and the service provider, the mobile communication device is unable to receive the content communicated by the advertiser through the service provider. Also, in case of poor data connectivity between the mobile communication device and the service provider, the mobile communication device may be unable to retrieve the content communicated by the advertiser through the service provider. Further, the content may be improperly communicated to the mobile communication device due to poor data connectivity. Therefore, the advertiser may be unable to provide the content, targeted to the users using the mobile communication devices in case of one or more of poor data connectivity and absence of data connectivity. Since the advertiser is unable to communicate the content, revenue earned by a manufacturer of the product and services may be adversely affected.

Therefore, there arises a need to improve accessibility of the advertising content for the mobile communication device irrespective of the availability and quality of data connectivity in the communication network.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1 illustrates an exemplary representation of a mobile communication device 100 in accordance with an embodiment of the invention.

FIG. 2 illustrates a method of rendering advertising contents on a mobile communication device in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to method for rendering advertising contents on a mobile communication device. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional transaction-clients and unique stored program instructions that control the one or more transaction-clients to implement, in conjunction with certain non-transaction-client circuits, some, most, or all of the functions of a method for advertising of the set of advertising contents on the mobile communication device. The non-transaction-client circuits may include, but are not limited to, a radio receiver, a radio transmitter, signal drivers, clock circuits, power source circuits, and user input devices. As such, these functions may be interpreted as steps of methods for advertising of the set of advertising contents on the mobile communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to various embodiments, the invention provides an apparatus and method for rendering a set of advertising contents provided by one or more advertisers on a mobile communication device. The set of advertising contents associated with one or more advertisers is embedded in a memory of the mobile communication device at the time of manufacturing of the mobile communication device. The set of advertising contents may include, but are not limited to a wallpaper, a ringtone, an alarm tone, a calendar, a theme, a logo, a jingle, an alert, a short message service (SMS), a multimedia message service (MMS), a Voice Message, an email, a game, a video, a screen saver, an audio advert and a splash screen. The one or more advertisers may be for example, but is not limited to, a manufacturer of products, a social organization and a service provider. The manufacturer of products may also be a manufacturer of the mobile communication device. An advertising content of the set of advertising contents is advertised on the mobile communication device based on detection of one or more of a user activity on the mobile communication device, a user location and one or more alerts associated with the mobile communication device. The user activity is one of one or more predefined user activities. The advertising content associated with the one or more of the user activity, the user location and the one or more alerts is identified based on a predefined set of rules. Upon identification of the advertising content, the advertising content is rendered on the mobile communication device. Thus, the advertising content is advertised to the user on the mobile communication device.

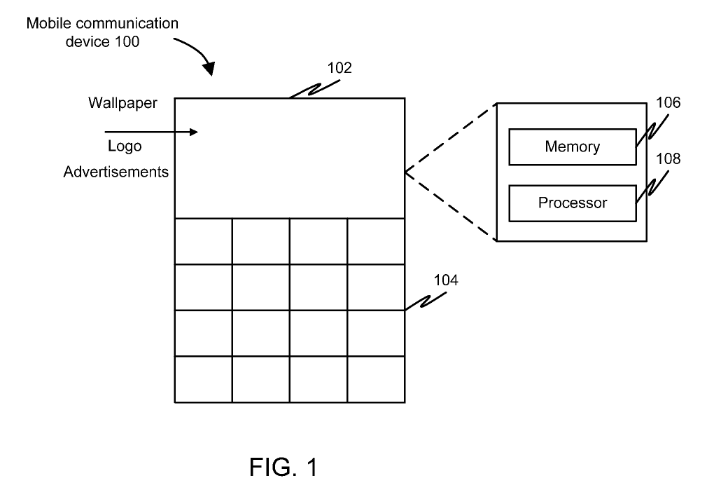

FIG. 1 represents a mobile communication device 100 in accordance with an embodiment of the invention. Mobile communication device 100 may include, but is not limited to a cellular phone, a Personal Digital Assistant (PDA), a laptop computer, and a Smart phone. Mobile communication device 100 may operate in a communication network (not shown). The communication network may include, but is not limited to an Enhanced Data Global System for Mobile communications (GSM) network (EDGE), a Second Generation (2G) network, 2.75G network, a 3rd Generation Partnership Project (3GPP) network including 3GPP Long Term Evolution (LTE) network, a 3rd Generation Partnership Project 2 (3GPP2) network including 3GPP2 Ultra Mobile Broadband (UMB) network, and a Wireless Fidelity (WiFi) network.

As illustrated in FIG. 1, mobile communication device 100 includes a display screen 102, a keypad 104, a memory 106 and a processor 108. Display screen 102 displays visual/graphical icons to a user of mobile communication device 100. The user interacts with the visual/graphical icons presented on display screen 102 by means of a positioning or input mechanism. The positioning or input mechanism may be keypad 104. It will be apparent to a person skilled in the art that a display screen such as, display screen 102 of mobile communication device 100 may be a touch screen display that enables the user to interact with mobile communication device 100. The visual/graphical icons represent a plurality of services and/or functionalities supported by mobile communication device 100. The plurality of services and the plurality of functionalities may be associated with, but are not limited to a wallpaper, a ringtone, an alarm tone, a calendar, a theme, a logo, a jingle, an alert, a short message service (SMS), a multimedia message service (MMS), a Voice Message, an email, a game, a video, a screen saver, an audio advert and a splash screen. The plurality of services and the plurality of functionalities are rendered to the user by processor 108 based on the user interaction with the visual/graphical icons.

A set of advertising contents are embedded in memory 106 of mobile communication device 100 by one or more advertisers at the time of manufacture of mobile communication device 100. The one or more advertisers may be a manufacturer of products, a social organization and a service provider. The manufacturer of products may also be a manufacturer of mobile communication device 100. The set of advertising contents associated with the one or more advertisers may be embedded in mobile communication device 100 based on an agreement between an advertising service provider and the one or more advertisers. The advertising service provider may be one of but not limited to, the manufacturer of mobile communication device 100 and an authorised platform service partner.

For example, a manufacturer of mobile communication device 100 may embed the set of advertising contents during the time of manufacture of mobile communication device 100. Alternatively, an authorised platform service partner may obtain mobile communication device 100 from the manufacturer and embed the set of advertising contents in mobile communication device 100. Thereafter, mobile communication device 100 may be provided to the user.

The set of advertising contents may include, but are not limited to a wallpaper, a ringtone, an alarm tone, a calendar, a theme, a logo, a jingle, an alert, a short message service (SMS), a multimedia message service (MMS), a Voice Message, an email, a game, a video, a screen saver, an audio advert and a splash screen. The set of advertising contents may be in one of an audio format, a video format, an image format and a multimedia format. For example, a wall paper, a theme and a logo may be in a JPEG format or a bitmap format. Whereas, a jingle and an alert may be in a MPEG format.

In an embodiment, the set of advertising contents are embedded in mobile communication device 100 based on a predefined criteria associated with the user. The predefined criteria may be one or more of but not limited to, a brand to be advertised to the user, demographic information associated with the user, a geographical location associated with the user, a social information and a religion associated with the user. The demographic information may include but are not limited to, an age, a gender and an occupation of the user. The set of advertising contents may be customized based on the predefined criteria and embedded in mobile communication device 100.

Moreover, during manufacturing of mobile communication devices, different batches of mobile communication devices may have different sets of advertising contents embedded in their memory. Since the one or more advertisers uses the mobile communication devices to advertise the set of advertising contents, the manufacturer and the advertising service provider may charge the one or more advertisers for advertising the set of advertising contents. Thus, the one or more advertisers may contribute to subsidizing the cost of the mobile communication device. As a result, cost incurred by the user such as, a consumer in obtaining the mobile communication device from the manufacturer is significantly reduced.

For example, once a tourist checks in a hotel, the tourist may be provided with mobile communication device 100. Mobile communication device 100 may be embedded with a first set of advertising contents. The first set of advertising contents may be predetermined by authorities of the hotel. Hence, mobile communication device 100 is embedded with the first set of advertising contents at the time of manufacture of mobile communication device 100. The first set of advertising contents may include a calendar. The calendar may include a stay schedule along with a cost schedule corresponding to the stay of the tourist in the hotel. Further, the first set of advertising contents may also include a phone directory including contact details of concerned persons associated with one or more services provided by the hotel. One or more services may be laundry, restaurant and room cleaning. In an instance, the phone directory may also include contact details of the concerned person of these services located in a region in which the hotel is situated. Also, the first set of advertising contents may further include details regarding locations of worship places in the proximity of the hotel based on a religion followed by the user.

In addition, mobile communication device 100 may include a second set of advertising contents provided by one or more service providers offering tourism services to tourists present in the hotel. A service provider of the one or more service providers may be a tourism department of a state in which the hotel is located. Mobile communication device 100 may further include a third set of advertising contents. The third set of advertising contents may be a ringtone and a wall paper of a brand named Coke™. Such a third set of advertising contents may encourage the tourist to get products of Coke™ available in a restaurant near to the hotel.

Since, the first set of advertising contents, the second set of advertising contents and the third set of advertising contents are embedded at the time of manufacture of mobile communication device 100, these advertising contents are readily available to the tourist irrespective of the availability and quality of a data connectivity of mobile communication device 100. Further, in this case, the hotel authorities and the one or more advertisers may contribute to subsidizing the cost of mobile communication device 100.

In another example, a consumer purchasing a car is provided with mobile communication device 100 by a dealer of the car. Mobile communication device 100 includes a first set of advertising contents embedded by the dealer of the car. The first set of advertising contents includes a calendar. The calendar may include a schedule to be followed by the consumer for servicing the car. The first set of advertising contents may also include a plurality of promotional deals and a new range of cars to be launched shortly. Further, mobile communication device 100 may include a second set of advertising contents. The second set of advertising contents may be provided by an advertiser such as, an insurance company named MetLife™. Thus, the second set of advertising contents may include one or more of a car insurance policy advertisement, a life insurance policy advertisement and a home insurance plan advertisement embedded in mobile communication device 100. Thus, the consumer is aware of the car insurance policy and other products offered by MetLife™. As a result, time required by the consumer for identifying a car insurance provider may be reduced. Additionally, the consumer may become aware of other insurance policies that may be of interest to the consumer. By leveraging such an advertising platform the advertiser is able to reach a new customer which in turn has created an opportunity to cross-sell and up-sell other products in their portfolio.

Moreover, in this scenario, it may happen that the amount of first set of advertising contents may be more that the second set of advertising contents. Therefore, the dealer of the car may contribute more to the cost of mobile communication device 100 than MetLife™. Since, one or more advertisers share the cost of mobile communication 100, mobile communication device 100 may be available to the user at a reduced cost. This reduced cost may result in increased sales of mobile communication devices. Moreover, the increased sales lead to effective mass advertisements for the one or more advertisers. Further, since these advertising contents are embedded in mobile communication device 100 at the time of procurement of mobile communication device 100, there is an assured accessibility of the set of advertising contents by the consumer. Thus, the effective mass advertisement targeted to the consumer of mobile communication device 100 is achieved.

Referring back to the set of advertising contents, an advertising content of the set of advertising contents is associated with one or more of the user activity, the user location and one or more alerts associated with mobile communication device 100. The user activity is one of the one or more predefined user activities defined in mobile communication device 100. The one or more predefined user activities may be defined by the advertising service provider. The one or more predefined user activities may include for example, but are not limited to switching on or off of mobile communication device 100, selecting the visual/graphical icons presented on display screen 102 and any other user interactions with mobile communication device 100. The user location is the location of mobile communication device 100 of the user. The location of the user may be determined using a Global Position System (GPS) that communicates with mobile communication device 100.

The one or more alerts associated with mobile communication device 100 may include, but are not limited to a pending calendar activity, a battery status, an alarm setting, birthday and/or anniversary reminders, incoming call alerts, incoming message alerts and missed call reminders. The one or more alerts may be set by the user of mobile communication device 100 or predefined in mobile communication device 100 by the manufacturer of mobile communication device 100. These alerts in mobile communication device 100 may facilitate display of an advertising content that is related to a context of the alert to the user. The context may be a birthday, or an anniversary.

For example, an alert may be generated by mobile communication device 100 when an email message is received in mobile communication device 100. The email message may include a subject line as “Happy Birthday”. The alert generated based on the mobile communication device interpreting the word “Happy Birthday” may trigger a relevant advertising content typically associated with birthdays to the user of the mobile communication device 100. For example, a wallpaper depicting an advertisement for sending flowers may be displayed.

In an embodiment, the advertising content may be associated with one or more of the user activity, the user location and the one or more alerts based on a predefined set of rules. The predefined set of rules is associated with the agreement between the advertising service provider and the one or more advertisers. The agreement may define rules associated with embedding the set of advertising contents in memory 106. The agreement may also define rules relating to association of each of the set of advertising contents with one or more user activities of the one or more predefined user activities, a user location and one or more alerts associated with mobile communication device 100.

Based on the agreement, an advertising content of the set of advertising contents embedded in mobile communication device 100 may be made active for a predefined period. The predefined period for which the advertising content is active is be defined in the agreement. Once the predefined period elapses, processor 108 erases the advertising content from memory 106 or makes the advertising content inactive. For example, an advertiser, such as, Kingfisher™, provides a plurality of wallpapers to mobile communication device 100. The plurality of wallpapers embedded in mobile communication device 100 is made active for a predefined period such as, one year. In this case, the plurality of wallpapers becomes inactive when the predefined period of one year lapses.

Once the user initiates a user activity on mobile communication device 100, the user activity is detected by processor 108. Thereafter, processor 108 identifies an advertising content associated with the user activity by referring to the predefined set of rules included in the agreement. Alternatively, processor 108 may identify an advertising content based on a user location. Furthermore, processor 108 may identify an advertising content based on detection of the one or more alerts of mobile communication device 100. Processor 108 then retrieves the advertising content from memory 106 for rendering to the user on display screen 102. The advertising content identified from the set of advertising contents may be rendered on display screen 102 in a predefined manner. In an embodiment, one or more advertising contents of the set of advertising contents is rendered on display screen 102 in a predefined arranged manner. The manner of arrangement of the one or more advertising contents may be decided by the one or more advertisers and the advertising service provider.

In an embodiment, association of the set of advertising contents with the one or more predefined user activities, the user location and the one or more alerts associated with mobile communication device 100 may be changed based on predefined association rules. The predefined association rules may include dynamically modifying the association of the set of advertising contents over a first predefined time interval. The association of the set of advertising contents may be modified automatically. Additionally, the predefined association rules may also include modifying the association based on user preferences.

For example, a user activity such as, switching on mobile communication device 100 may result in rendering of a Kingfisher™ logo on display screen 102 for a predefined time interval as defined by the predefined association rules. Once, the predefined time interval lapses, processor 108 renders a Vodafone™ logo on display screen 102 in response to switching on mobile communication device 100. The Vodafone™ logo may be rendered based on the predefined association rules.

In an embodiment, the one or more advertising contents may be updated over a second predefined time interval. Processor 108 may update the one or more advertising contents by modifying an arrangement of the one or more advertising contents on display screen 102. Alternatively, processor 108 may update the one or more advertising contents by automatically replacing the one or more advertising contents with new advertising contents based on instructions from one or more advertisers. Mobile communication device 100 may be reprogrammed to replace the one or more advertising contents with the new advertising contents. The one or more advertising contents are replaced with new advertising contents during availability of the data connectivity in the communication network. The new advertising contents may be automatically communicated by the one or more advertisers once the second predefined time interval elapses. In another scenario, the user of mobile communication device 100 may request the one or more advertisers for updating the one or more advertising contents.

In another embodiment, the set of advertising contents on mobile communication device 100 may be un-modifiable by the user. For example, the set of advertising contents may not be deleted, replaced or edited by the user. However, the set of advertising contents may be modifiable during servicing of mobile communication device 100. During servicing, the service provider may modify the set of advertising contents with new advertising contents provided by the one or more advertisers. The one or more advertisers may communicate the new advertising contents to the service provider at a predefined time period. Additionally, the service provider may be a reseller or an authorised platform service partner. For example, a Dominos Pizza™ outlet may upload their latest pizza menus, promotions and coupons on mobile communication device 100.

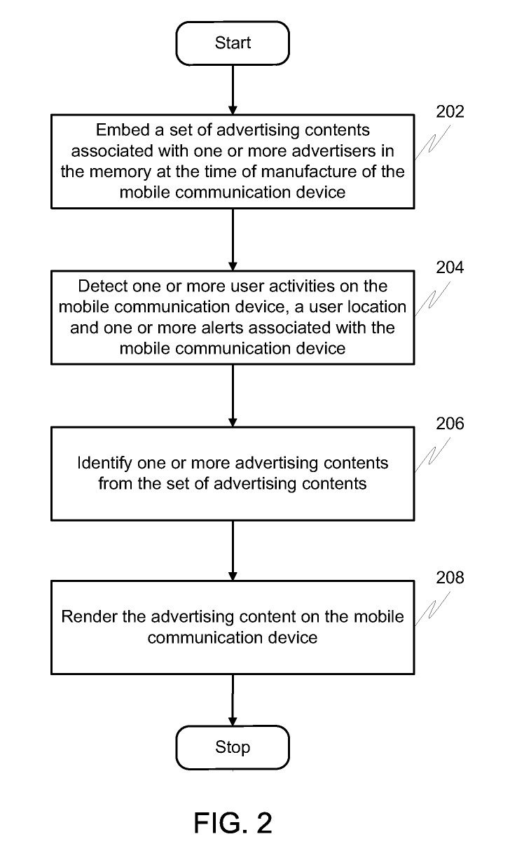

FIG. 2 represents a method of rendering a set of advertising contents associated with one or more advertisers in a mobile communication device in accordance with an embodiment of the invention. The set of advertising contents are embedded in the mobile communication device by the one or more advertisers at the time of manufacture of the mobile communication device, at step 202.

The one or more advertisers may be a manufacturer of products, a social organization and a service provider. The manufacturer of products may also be a manufacturer of the mobile communication device. In an embodiment, the set of advertising contents are embedded in the mobile communication device based on a predefined criteria associated with the user. The predefined criteria is already explained in detail in conjunction with FIG. 1. The set of advertising contents may be customized based on the predefined criteria and embedded in the mobile communication device.

An advertising content of the set of advertising contents is associated with one or more of a user activity, a user location and one or more alerts associated with the mobile communication device. The user activity is one of the one or more predefined user activities defined in the mobile communication device. The user activity may include for example, but are not limited to switching on or off of a mobile communication device, selecting the visual/graphical icons presented on the mobile communication device and any other user interactions with the mobile communication device. The user location is the location of the mobile communication device of the user. The one or more alerts associated with the mobile communication device may be but are not limited to a pending calendar activity, a battery status, an alarm setting, birthday and/or anniversary reminders and missed call reminders. The one or more alerts may be set by the user of mobile communication device 100 or predefined in mobile communication device 100 by the manufacturer of mobile communication device 100.

The advertising content may be associated with the one or more of the user activity, the user location and the one or more alerts based on a predefined set of rules. The predefined set of rules is associated with an agreement between an advertising service provider and the one or more advertisers. The advertising service provider may be one of but not limited to, the manufacturer of mobile communication device 100 and an authorised platform service partner. The agreement may define rules associated with embedding the set of advertising contents in the memory. The agreement may also include rules relating to association of each of the set of advertising contents with one or more user activities of the one or more predefined user activities and the user location and the one or more alerts associated with the mobile communication device.

Further, the one or more of user activities on the mobile communication device, a user location and one or more alerts associated with the mobile communication device is detected, at step 204. Thereafter, an advertising content associated with the user activity is identified by referring to the predefined set of rules, at step 206. This is explained in detail in conjunction with FIG. 1.

Thereafter, the advertising content is rendered to the user on communication device 100, at step 208. The advertising content of the set of advertising contents may be rendered on display screen 102 in a predefined manner as agreed by the one or more advertisers and the advertising service provider. One or more advertising contents of the set of advertising contents rendered on display screen 102 in a predefined arranged manner. The manner of arrangement of the one or more advertising contents may be decided by the one or more advertisers and the advertising service provider. The advertising content may be rendered as, but are not limited to a wallpaper, a ringtone, an alarm tone, a calendar, a theme, a logo, a jingle, an alert, a short message service (SMS), a multimedia message service (MMS), a Voice Message, an email, a game, a video, a screen saver, an audio advert and a splash screen.

In an embodiment, association of the set of advertising contents with the one or more predefined user activities, the user location and the one or more alerts associated with mobile communication device 100 may be changed based on a predefined association rules. The predefined association rules may include dynamically modifying the association of the set of advertising content over a first predefined time interval. The association of the set of advertising contents may be modified automatically. Additionally, the predefined association rules may also include modifying the association based on user preferences.

In an embodiment, the one or more advertising contents may be updated over a second predefined time interval. Processor 108 may update the one or more advertising contents by modifying an arrangement of the one or more advertising contents on display screen 102. Alternatively, processor 108 may update the one or more advertising contents by automatically replacing the one or more advertising contents with new advertising contents based on instructions from one or more advertisers. Mobile communication device 100 may be reprogrammed to replace the one or more advertising contents with the new advertising contents. The one or more advertising contents are replaced with new advertising contents during availability of the data connectivity in the communication network. The new advertising contents may be automatically communicated by the one or more advertisers once the second predefined time interval elapses. In another scenario, the user of mobile communication device 100 may request the one or more advertisers for updating the one or more advertising contents.

Consider an exemplary embodiment, wherein Nokia™, a manufacturer of a mobile communication device, enter into an agreement with advertisers such as, Vodafone™, a hotel authority and Kingfisher™. The agreement may be between the advertisers and an authorised platform service partner. The authorised platform service partner obtains the mobile communication device from Nokia™. The agreement allows these advertisers to advertise their advertising contents in a mobile communication device manufactured by Nokia™. Moreover, based on the agreement, the advertisers may contribute towards the manufacturing cost of the mobile communication device, which in turn may enable Nokia™ to supply the mobile communication device to consumers at a subsidized cost. The advertising contents may include a first advertising content, a second advertising content and a third advertising content. The first advertising content may be a logo of Vodafone™ provided by Vodafone™. The second advertising content may be a phone directory provided by a hotel authority. The phone directory may include contact details of concerned persons that provide one or more services to a tourist staying in the hotel. One or more services may be a travel agency, eating outlets and laundry services in a region where the hotel is located. The third advertising content may be a wall paper and a ringtone offered by Kingfisher™. These advertisement contents are embedded in the mobile communication device at the time of manufacture of the mobile communication device.

When the tourist arrives in the hotel, the hotel authority may provide the tourist with the mobile communication device. The tourist then switches on the mobile communication device. In response to switching on the mobile communication device, the logo of Vodafone™ is retrieved from the memory and displayed on a display screen of the mobile communication device. Additionally, the wallpaper of Kingfisher™ is retrieved and displayed as a wallpaper on the display screen. The tourist may then interact with graphical icons presented on the display screen to access the one or more services offered by the hotel. During interaction with the graphical icons, one or more advertisement contents corresponding to the one or more services are rendered on the display screen. For example, the tourist may access a graphical icon and advertising contents associated with a travel agency may be displayed on the display screen of the mobile communication device. The advertising contents may include a phone directory showing contact details of the travel agency. The advertising contents may also include a set of advertisements of the travel agency. Since these advertising contents are embedded at the time of manufacture of the mobile communication device, the advertising contents may be rendered to the tourist even in absence of a data connectivity. The advertising contents may be updated in the mobile communication device over a predefined time interval.

The mobile communication device of the tourist may have the ringtone of Kingfisher™ set as a default ringtone. Thus, when the tourist receives a call in the mobile communication device, the ringtone of Kingfisher™ is rendered. The default ringtone may be active for a predefined period. The manufacturer Nokia™ may set the predefined period for which the default ringtone may be active in the mobile communication device.

Various embodiments of the invention provide an apparatus and method for presenting advertising contents targeted to the user. A set of advertising contents is provided by one or more advertisers to a user using a mobile communication device. The set of advertising contents is embedded in the mobile communication device at time of manufacture. Therefore, the set of advertising contents is accessible by the user irrespective of the availability and quality of data connectivity. Further, since the one or more advertisers use the mobile communication devices to advertise the set of advertising contents, the manufacturer may charge the one or more advertisers for advertising the set of advertising contents. Thus, the one or more advertisers may contribute to subsidizing the cost of the mobile communication device. As a result, cost incurred by the user such as, a consumer in obtaining the mobile communication device from the manufacturer is significantly reduced. This in turn may increase the sales of the mobile communication device which thereby resulting in effective mass advertisements for one or more advertisers.

Those skilled in the art will realize that the above recognized advantages and other advantages described herein are merely exemplary and are not meant to be a complete rendering of all of the advantages of the various embodiments of the invention.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A mobile communication device comprising:
a memory, wherein a set of advertising contents associated with at least one advertiser is embedded in the memory at the time of manufacture of the mobile communication device; and
a processor coupled with the memory, the processor configured to:
detect at least one of a user activity on the mobile communication device, a user location and at least one alert associated with the mobile communication device, wherein the user activity is one of at least one predefined user activities;
identify at least one advertising content from the set of advertising contents in response to detection of at least one of the user activity on the mobile communication device, the user location and the at least one alert associated with the mobile communication device, wherein the at least one advertising content is associated with at least one of the user activity, the user location and the at least one alert based on a predefined set of rules associated with an advertising service provider and the at least one advertiser; and
render the at least one advertising content on the mobile communication device.

2. The mobile communication device of claim 1, wherein the at least one advertising content comprises at least one of one of a wallpaper, a ringtone, an alarm tone, a calendar, a theme, a logo, a jingle, an alert, a short message service (SMS), a multimedia message service (MMS), a game, a video, a screen saver, an audio advert and a splash screen.

3. The mobile communication device of claim 2, wherein an advertising content of the set of advertising contents is in one of an image format, an audio format, a video format and a multimedia format.

4. The mobile communication device of claim 1, wherein the set of advertising contents is embedded in the mobile communication device based on a predefined criteria associated with the user.

5. The mobile communication device of claim 4, wherein the predefined criteria is at least one of a brand to be advertized to the user, a demographic information associated with the user, a geographical location associated with the user, a social information and a religion associated with the user.

6. The mobile communication device of claim 1, wherein the predefined set of rules is associated with an agreement between the at least one advertiser and the advertising service provider, the agreement defines at least one of embedding the set of advertising contents in the memory and associating each of the set of advertising contents with at least one of a user activity of the at least one predefined user activities, a user location and at least one alert associated with the mobile communication device.

7. The mobile communication device of claim 6, wherein the association of each of the set of advertising contents with at least one of the user activity of the at least one predefined user activities, the user location and the at least one alert associated with the mobile communication device is dynamically modified based on at least one of a first predefined time interval and user preferences.

8. The mobile communication device of claim 1, wherein the processor is further configured to update the at least one advertising content of the set of advertising contents at a second predefined time interval based on at least one of a request from the user and instructions from the at least one advertiser.

9. The mobile communication device of claim 1, wherein an advertiser of the at least one advertiser is one of a manufacturer of products, a social organization and a service provider.

10. The mobile communication device of claim 1, wherein the mobile communication device is one of a cellular phone, a Personal Digital Assistant (PDA), a laptop computer and a smart phone.

11. A method for advertising in a mobile communication device, wherein the mobile communication device comprises a memory, the method comprising:
embedding a set of advertising contents associated with at least one advertiser in the memory at the time of manufacture of the mobile communication device;
detecting at least one of a user activity on the mobile communication device, a user location and at least one alert associated with the mobile communication device, wherein the user activity is one of at least one predefined user activities;
identifying at least one advertising content from the set of advertising contents in response to detecting at least one of the user activity on the mobile communication device, the user location and the at least one alert associated with the mobile communication device, wherein the at least one advertising content is associated with at least one of the user activity, the user location and the at least one alert based on a predefined set of rules associated with a an advertising service provider and the at least one advertiser; and
rendering the at least one advertising content on the mobile communication device.

12. The method of claim 11, wherein the set of advertising contents is embedded in the mobile communication device based on a predefined criteria associated with the user.

13. The method of claim 11, wherein the predefined set of rules is associated with an agreement between the at least one advertiser and the advertising service provider, the agreement defines at least one of embedding the set of advertising contents in the memory and associating each of the set of advertising contents with at least one of a user activity of the at least one predefine user activities, a user location and at least one alert associated with the mobile communication device.

14. The method of claim 13, wherein the association of each of the set of advertising contents with at least one of the user activity of the at least one predefined user activities, the user location and the at least one alert associated with the mobile communication device is dynamically modified based on at least one of a first predefined time interval and user preferences.

15. The method of claim 11 further comprising updating the at least one advertising content of the set of advertising contents at a second predefined time interval based on at least one of a request from the user and instructions from the at least one advertiser.
